(19) United States
(12) Patent Application Publication
(10) Pub. No.: US 2016/0190889 A1
(43) Pub. Date: Jun. 30, 2016

(54) Brushed Direct Current Motor

(71) Applicant: Johnson Electric S.A., Murten (CH)

(72) Inventors: Fei Liu, Shenzhen (CN); Rui Feng Qin, Hong Kong (CN)

(21) Appl. No.: 14/985,996

(22) Filed: Dec. 31, 2015

(30) Foreign Application Priority Data
Dec. 31, 2014 (CN) 201410855959.3

(51) Int. Cl. H02K 3/28; H02K 13/00; H02K 13/04

(52) U.S. Cl. CPC H02K 3/28; H02K 13/04; H02K 13/006

(57) ABSTRACT

A brushed DC motor has a stator and a rotor. The stator has 2P magnetic poles, where P is an integer greater than 1. The rotor has a shaft, a rotor core, a commutator and a winding. The rotor core has m×P teeth, where m is an integer greater than 2. The winding includes several coil windings wound on the teeth and electrically connected to segments of the commutator. The commutator has 2m×P segments, where the 2m×P segments are divided into 2m groups, each group has P segments, the P segments are connected by an equalizer. The equalizer for at least one group of the 2m groups of segments and all the coil windings are formed by a single winding wire, wound continuously.

### CROSS REFERENCE TO RELATED APPLICATIONS

This non-provisional patent application claims priority under 35 U.S.C. §119(a) from Patent Application No. 201410855959.3 filed in The People's Republic of China on Dec. 31, 2014, the entire contents of which are hereby incorporated by reference.

### FIELD OF THE INVENTION

This invention relates to electric motors and in particular, to a direct current (DC) motor having brushes.

### BACKGROUND OF THE INVENTION

Conventional brushed DC motor includes a stator and a rotor, the rotor includes a shaft, a commutator fixed to the shaft, a rotor core fixed to the shaft, a winding wound on teeth of the rotor core and electrically connected to segments of the commutator. The stator has electric brushes making sliding electrical contact with the segments, thereby supplying power to the winding.

In order to reduce the number of electric brushes, an equalizer is generally added to the commutator, and several segments connected to a same equalizer are equipotential. Hence, when one of the several segments is contacted by a brush it is equivalent to all of the several segments being contacted by the brush.

Conventional commutators having an equalizer have a complex structure, with a low manufacturing efficiency.

### SUMMARY OF THE INVENTION

Hence there is a desire for a brushed DC motor having an improved winding and equalizer arrangement.

Accordingly, in one aspect thereof, the present invention provides a brushed DC motor, comprising: a stator comprising 2P magnetic poles, wherein P is an integer greater than 1; a rotor rotatably mounted onto the stator, wherein the rotor comprises a shaft, a rotor core fixed to the shaft, a commutator and a winding; the rotor core has m×P teeth, m is an integer greater than 2; the commutator has 2m×P segments; the winding comprises several coil windings wound on the teeth and electrically connected to a respective segment, wherein the 2m×P segments are divided into 2m groups, each group has P segments, the P segments are connected conductively via one equalizer sequentially, and wherein the equalizer for at least one group of the 2m groups of segments and all of the coil windings are formed by a continuous winding wire.

Preferably, each equalizer forms a closed loop.

Preferably, all of the equalizers and all of the coil windings of the rotor are formed by the continuous winding wire.

Preferably, a few of the coil windings and all of the equalizers are formed alternately and the remaining coil windings are formed sequentially.

Preferably, each of the coil windings is wound on a respective tooth, and two ends of each of the coil windings wind around the shaft by a mechanical angle of 90 degrees and are hooked up to two corresponding segments respectively.

Preferably, any two sequentially formed coil windings have opposite winding directions, wherein one of the coil windings is wound in a clockwise direction and the other of the coil windings is wound in a counter-clockwise direction.

Preferably, two coil windings are wound on each of the teeth, and the two coil windings have opposite winding directions.

Preferably, each of the coil windings comprises P sub-coils, the P sub-coils are wound on the P teeth of the rotor respectively; and a distance between two adjacent sub-coils among the P sub-coils is an even multiple of a pole pitch.

Preferably, each of the segments is connected directly to two coil windings, and the two coil windings have opposite winding directions.

Preferably, the stator has two electric brushes in electrical contact with the commutator, and six parallel branches are formed by the winding to be connected to the two electric brushes.

Alternatively, the stator has two electric brushes in electrical contact with the commutator, and two parallel branches are formed by the winding of the rotor to be connected to the two electric brushes.

Preferably, some of the segments are connected directly to two coil windings, and the two coil windings have opposite winding directions.

Preferably, P is equal to 3, and m is equal to 3.

Preferably, the following relational expression is met for the electric brushes and the commutator of the stator:

$${W}_{b} < {D}_{c} \cdot sin ( {sin}^{- 1} ( \frac{δ}{{D}_{c}} ) + \frac{π}{2 mP} )$$

wherein W_{b} indicates a width of the electric brush in a rotational direction of the commutator;
D_{c} indicates an outside diameter of the commutator; and
δ indicates a width of a gap between two adjacent segments of the commutator.

According to embodiments of the present invention, the equalizers of the commutator can be formed by the winding wire, and at least a few of the equalizers and all the coil windings are formed by continuous winding of the winding wire without cutting, thereby improving the winding efficiency. Certain embodiments reduce the number of the windings on a hook of the segment for connecting the equalizer and the coil winding, which is beneficial for attachment of the wire to the segments.

Hereinafter, the present invention is described by taking a permanent magnet brushed DC motor having six poles and nine slots as an example. It should be realized that, the present invention is not limited to the brushed DC motor having six poles and nine slots.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 is an exploded isometric view of a permanent magnet brushed DC motor according to a first embodiment of the present invention;

FIG. 2 illustrates a rotor of the motor of FIG. 1;

FIG. 3 is a schematic winding diagram for the rotor of FIG. 2;

FIG. 4 is a schematic top view of the rotor winding of FIG. 3, imposed on a core of the rotor;

FIG. 5 is a winding table for the rotor winding of FIG. 3;

FIG. 6 is a schematic winding diagram for a rotor according to a second embodiment of the present invention;

FIG. 7 is a schematic top view of the rotor winding of FIG. 6; and

FIG. 8 is a winding table for the rotor of FIG. 6.

### DETAILED DESCRIPTION OF THE PREFERRED EMBODIMENTS

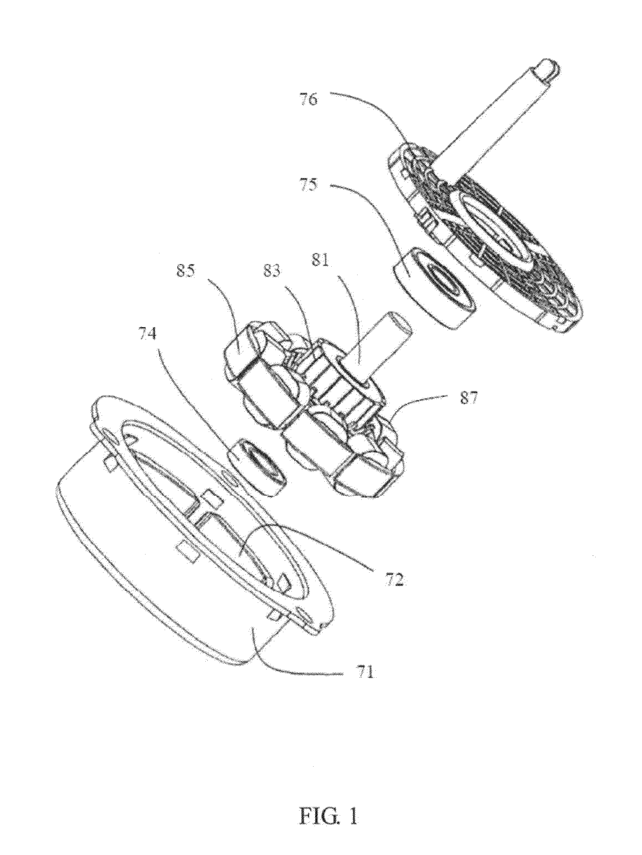

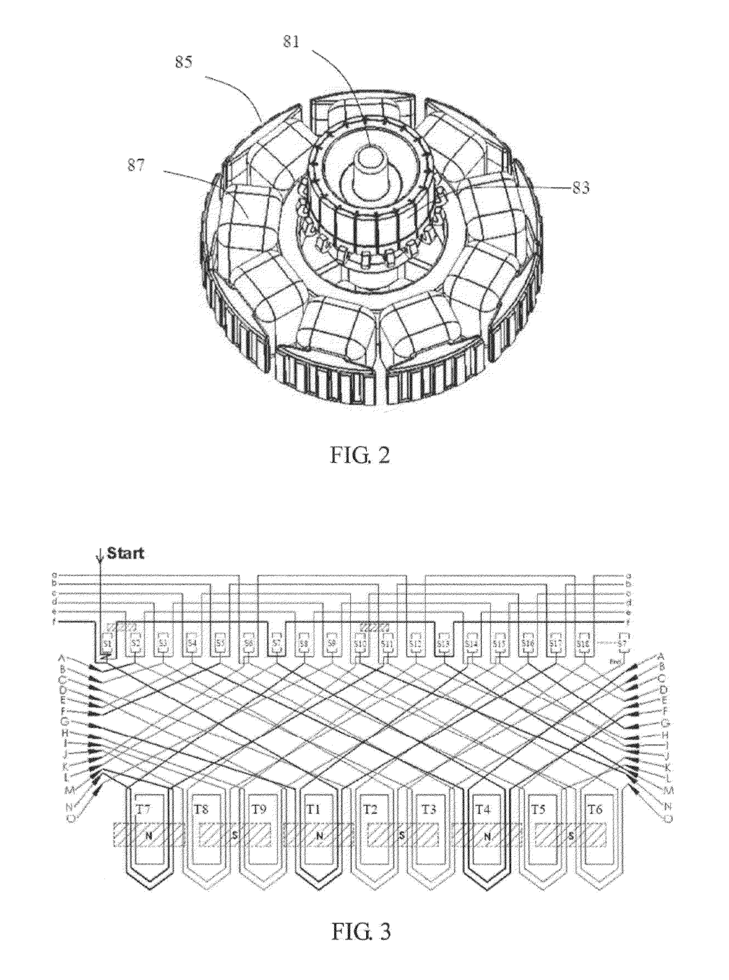

Referring to FIGS. 1 and 2, the motor according to the first embodiment includes a stator and a rotor.

The stator includes a housing 71, a number of permanent magnets 72 mounted on an inner wall of the housing, an end cap 76 mounted to an open end of the housing, a bearing 74 mounted on the housing 71 and a bearing 75 mounted on the end cap 76. Six magnetic poles are formed by the permanent magnets 72. P is equal to 3 (that is 2P is equal to 6) in this embodiment where P indicates the number of pole pairs of the motor.

The rotor includes a shaft 81, a commutator 83 fixed to the shaft 81, a rotor core 85 and a winding 87. The shaft 81 is rotatably supported by the bearings 74 and 75 so that the rotor is rotatable relative to the stator.

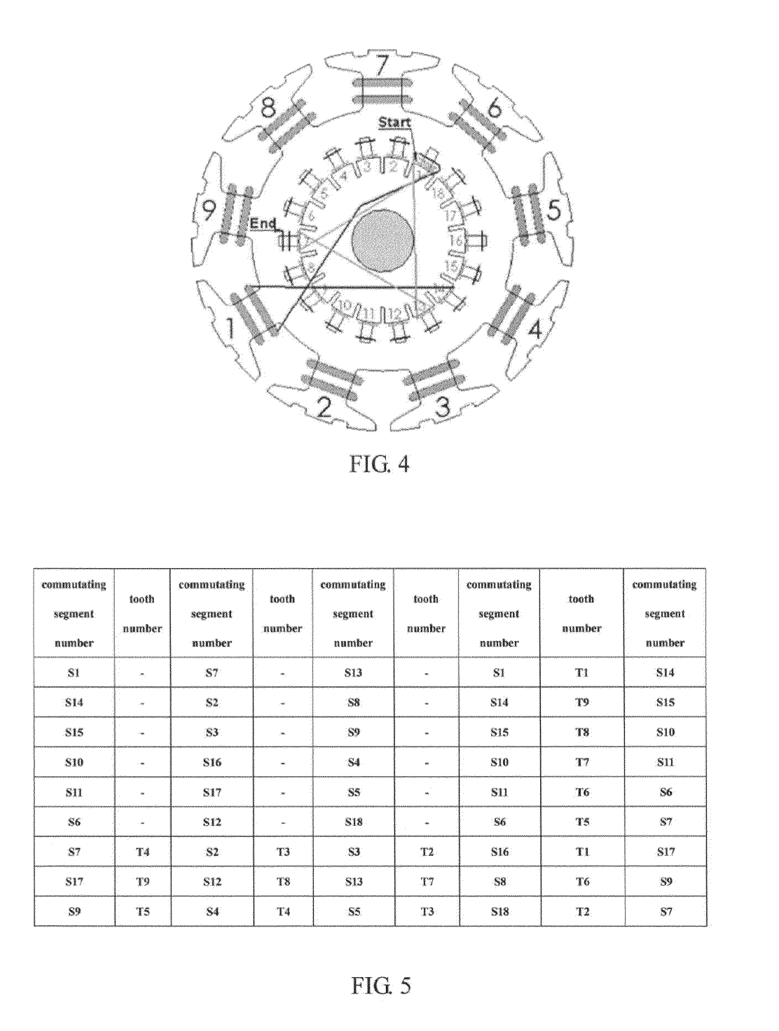

Referring to FIGS. 3 and 4, the rotor core 85 has nine teeth T1 to T9, and a winding slot is formed between adjacent teeth for accommodating coils of the winding 87. In this embodiment, the number of teeth of the rotor is an integral multiple of the number of pole pairs of the stator. P is equal to 3 and m is also equal to 3 where m×P indicates the number of teeth of the rotor.

In this embodiment, the commutator has eighteen segments 83, and the number of the segments 83 is twice the number of teeth, which is six times the number P of the pole pairs.

Hereinafter, the rotor winding and an equalizer for the commutator 83 according to the embodiment are described in conjunction with FIGS. 3, 4 and 5. In FIG. 3, two rectangular blocks in the first row indicate two electric brushes of the stator, where the polarity of one electric brush is positive and the polarity of the other electric brush is negative. Rectangular blocks in the second row indicate eighteen segments S1 to S18 of the commutator 83. It should be noted that one of the segments in FIG. 3 is repeated. Rectangular blocks arranged in the third row indicate nine teeth T1 to T9 of the rotor. Blocks arranged between the teeth indicate six magnetic poles of the stator, which includes three N poles and three S poles, and the N poles and the S poles are arranged alternately.

In the first embodiment, where the number of segments is used to measure the pole pitch (the pole pitch refers to a distance between an S pole and an N pole which are adjacent), one pole pitch corresponds to three segments (that is 18/6 is equal to 3). It is known by those skilled in the art that segments at a distance of two (or an integral multiple of 2) pole pitches are equipotential segments, in other words, equipotential segments correspond to the permanent magnet 72 of a same magnetic pole. In this embodiment, equipotential segments are separated by six segments where the number of the segments indicates a distance between equipotential segments. For example, segments S1, S7 and S13 are a group of equipotential segments. Similarly, segments S2, S8 and S14 are a group of equipotential segments, segments S3, S9 and S15 are a group of equipotential segments, segments S4, S10 and S16 are a group of equipotential segments, segments S5, S11 and S17 are a group of equipotential segments, and segments S6, S12 and S18 are another group of equipotential segments. Each group of equipotential segments has three (equal to the number P of the pole pairs) segments, the eighteen segments are divided into six groups (18/P). For a motor including 2P magnetic poles and 2m×P segments, the segments may be divided into 2m groups, and each group has P equipotential segments.

In the first embodiment, the winding wire is hooked up to the segment S1, then the winding wire is hooked up to the segment S7 and the segment S13 sequentially and returned to the segment S1. Thus a closed-loop equalizer is formed, with which segments S1, S7 and S13 are electrically shorted together.

Next, the winding wire is wound around the tooth T1 by several turns in a clockwise direction from the segment S1, then the winding wire is hooked up to the segment S14, and thus a coil winding is formed, of which two ends are electrically connected to the segment S1 and the segment S14 respectively. In the embodiment, the ends of the coil winding wound on the tooth T1 extend around the shaft by a mechanical angle of 90 degrees and are hooked up to two segments S1 and S14 from opposite sides of the shaft respectively, hence, the two ends of the coil winding are near to the shaft (see FIG. 4).

Next, the winding wire is hooked up to the segment S2 and the segment S8 sequentially from the segment S14 and returned to the segment S14, and thus a second closed-loop equalizer is formed, with which the segment S2, the segment S8 and the segment S14 are electrically connected together.

Next, the winding wire is wound around the tooth T9 by several turns in a counter-clockwise direction from the segment S14, then the winding wire is hooked up to the segment S15, and thus a coil winding is formed. Ends of the coil winding wind around the shaft by a mechanical angle of 90 degrees and are hooked up to two segments S14 and S15 from two sides of the shaft respectively (see FIG. 4).

Similarly, the winding wire is hooked up to the segment S3 and the segment S9 sequentially from the segment S15 and returned to the segment S15, and thus a closed-loop equalizer is formed, with which segments S15, S3 and S9 are electrically connected together.

Next, the winding wire is wound around the tooth T8 by several turns in a clockwise direction from the segment S15, then the winding wire is hooked up to the segment S10, and thus a coil winding is formed. Similar to the coil winding wound on the tooth T1 in a clockwise direction, two ends of the coil winding wind around the shaft by a mechanical angle of 90 degrees and are hooked up to two segments S15 and S10 from opposite sides of the shaft respectively. Furthermore, a mechanical angle formed by the ends of the coil winding extending around the shaft is in a range from 90 degrees to 180 degrees.

Next, the winding wire is hooked up to the segment S16 and the segment S4 sequentially from the segment S10 and returned to the segment S10, and thus a closed-loop equalizer is formed, with which segments S10, S16 and S4 are electrically connected together.

Next, the winding wire is wound around the tooth T7 by several turns in a counter-clockwise direction from the segment S10, then the winding wire is hooked up to the segment S11, and thus a coil winding is formed.

Next, the winding wire is hooked up to the segment S17 and the segment S5 sequentially from the segment S11 and returned to the segment S11, and thus a closed-loop equalizer is formed, with which segments S11, S17 and S5 are electrically connected together.

Next, the winding wire is wound around the tooth T6 by several turns in a clockwise direction from the segment S11, then the winding wire is hooked up to the segment S6, and thus a coil winding is formed.

Next, the winding wire is hooked up to the segment S12 and the segment S18 sequentially from the segment S6 and returned to the segment S6, and thus a closed-loop equalizer is formed, with which segments S6, S12 and S18 are electrically connected together.

Next, the winding wire is wound around the tooth T5 by several turns in a counter-clockwise direction from the segment S6, then the winding wire is hooked up to the segment S7, and thus a coil winding is formed.

The remaining coil windings are now wound sequentially since all of the equalizers have been wound. Specifically, the winding wire is wound around the tooth T4 by several turns in a clockwise direction from the segment S7, then the winding wire is hooked up to the segment S2, and thus a coil winding is formed. The winding wire is wound around the tooth T3 by several turns in a counter-clockwise direction from the segment S2, then the winding wire is hooked up to the segment S3, and thus a coil winding is formed. The winding wire is wound around the tooth T2 by several turns in a clockwise direction from the segment S3, then the winding wire is hooked up to the segment S16, and thus a coil winding is formed. The winding wire is wound around the tooth T1 by several turns in a counter-clockwise direction from the segment S16, then the winding wire is hooked up to the segment S17, and thus a coil winding is formed.

The winding wire is wound around the tooth T9 by several turns in a clockwise direction from the segment S17, then the winding wire is hooked up to the segment S12, and thus a coil winding is formed. The winding wire is wound around the tooth T8 by several turns in a counter-clockwise direction from the segment S12, then the winding wire is hooked up to the segment S13, and thus a coil winding is formed. The winding wire is wound around the tooth T7 by several turns in a clockwise direction from the segment S13, then the winding wire is hooked up to the segment S8, and thus a coil winding is formed. The winding wire is wound around the tooth T6 by several turns in a counter-clockwise direction from the segment S8, then the winding wire is hooked up to the segment S9, and thus a coil winding is formed.

The winding wire is wound around the tooth T5 by several turns in a clockwise direction from the segment S9, then the winding wire is hooked up to the segment S4, and thus a coil winding is formed. The winding wire is wound around the tooth T4 by several turns in a counter-clockwise direction from the segment S4, then the winding wire is hooked up to the segment S5, and thus a coil winding is formed. The winding wire is wound around the tooth T3 by several turns in a clockwise direction from the segment S5, then the winding wire is hooked up to the segment S18, and thus a coil winding is formed. The winding wire is wound around the tooth T2 by several turns in a counter-clockwise direction from the segment S18, then the winding wire is hooked up to the segment S7, and thus a coil winding is formed. One end of the coil winding wound on the tooth T2 being connected to the segment S1 is equivalent to the end of the coil winding wound on the tooth T2 being connected to the segment S7 in a circuit since the segment S7 and the segment S1 are equipotential.

As mentioned above, in the first embodiment, all the equalizers for the rotor and all the coil windings of the rotor are formed by continuously winding a single piece winding wire, without cutting the winding wire, thereby improving the production efficiency significantly.

In this embodiment, the equalizers and a few of the coil windings are formed alternately. The remaining coil windings are formed sequentially once the equalizers have been completed.

In this embodiment, any two coil windings formed sequentially have opposite winding directions, where one of the coil windings is wound in a clockwise direction and the other of the coil windings is wound in a counter-clockwise direction.

In this embodiment, two coil windings are wound on each of the teeth, and the two coil windings wound on a single tooth have opposite winding directions.

In this embodiment, each of the segments is connected directly to two coil windings, and the two coil windings have opposite winding directions.

In this embodiment, six parallel branches are formed by the rotor winding to be connected in parallel to the two electric brushes in cooperation with the equalizer although only two electric brushes are used in the motor.

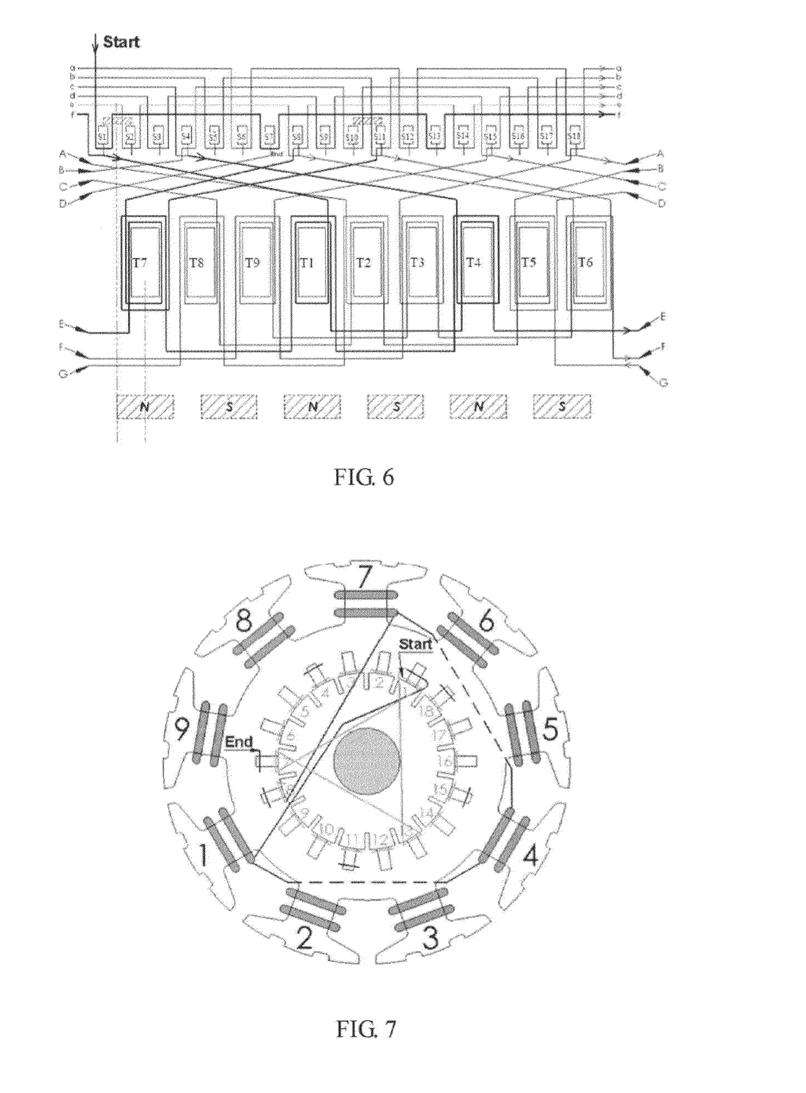

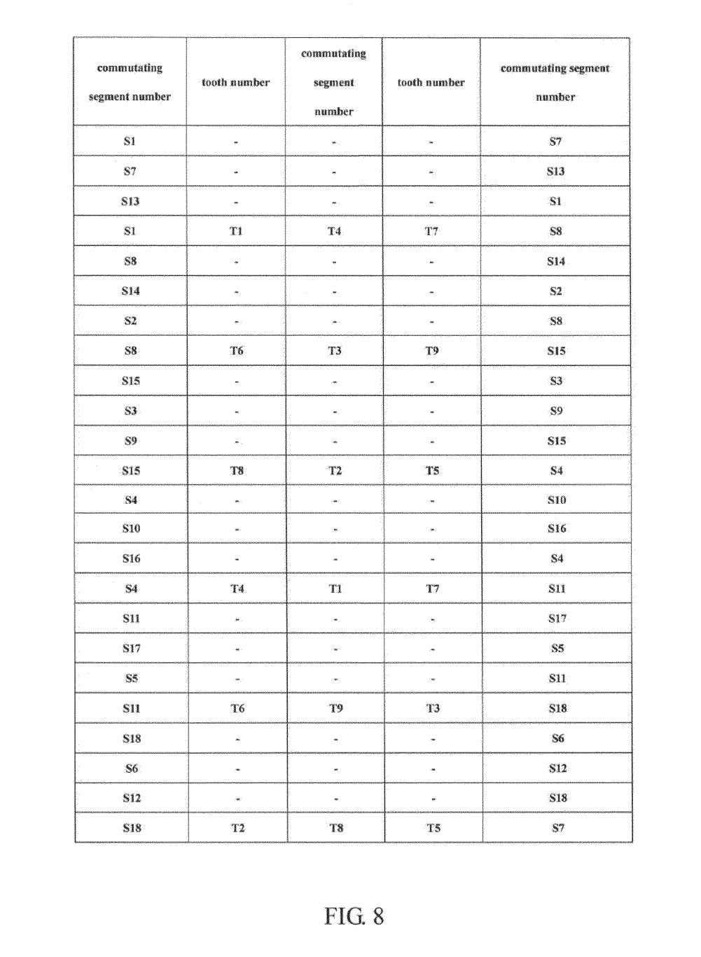

Referring to FIGS. 6, 7 and 8, a motor according to a second embodiment of the present invention comprises a stator having six magnetic poles (that is, 2P is equal to 6) and two electric brushes, a rotor having nine teeth T1 to T9 (that is, m×P is equal to 9), and a commutator having eighteen segments S1 to S18 (that is, 2m×P is equal to 18). In the second embodiment, the equalizers are still formed by a winding wire of the winding. The second embodiment differs from the above-described first embodiment in that, each of the coil windings are arranged on three teeth.

Specifically, in the second embodiment, the winding wire is hooked up to the segment S1, then the winding wire is hooked up to the segment S7 and the segment S13 sequentially and returned to the segment S1, and thus a closed-loop equalizer is formed, with which the segment S1, the segment S7 and the segment S13 are electrically connected together.

Next, the winding wire is wound around the tooth T1 by several turns in a clockwise direction from the segment S1, the winding wire is wound around the tooth T4 by several turns in a clockwise direction, the winding wire is wound around the tooth T7 by several turns in a clockwise direction, and then the winding wire is hooked up to the segment S8.

Next, the winding wire is hooked up to the segment S14 and the segment S2 from the segment S8 and returned to the segment S8, and thus a closed-loop equalizer is formed, with which the segments S8, S14 and S2 are electrically connected together.

Next, the winding wire is wound around the tooth T6 by several turns in a counter-clockwise direction from the segment S8, the winding wire is wound around the tooth T3 by several turns in a counter-clockwise direction, the winding wire is wound around the tooth T9 by several turns in a counter-clockwise direction, and then the winding wire is hooked up to the segment S15.

Next, the winding wire is hooked up to the segment S3 and the segment S9 from the segment S15 and returned to the segment S15, and thus a closed-loop equalizer is formed, with which segments S15, S3 and S9 are electrically connected together.

Next, the winding wire is wound around the tooth T8 by several turns in a clockwise direction from the segment S15, the winding wire is wound around the tooth T2 by several turns in a clockwise direction, the winding wire is wound around the tooth T5 by several turns in a clockwise direction, and then the winding wire is hooked up to the segment S4.

Next, the winding wire is hooked up to the segment S10 and the segment S16 from the segment S4 and returned to the segment S4, and thus a closed-loop equalizer is formed, with which segments S4, S10 and S16 are electrically connected together.

Next, the winding wire is wound around the tooth T4 by several turns in a counter-clockwise direction from the segment S4, the winding wire is wound around the tooth T1 by several turns in a counter-clockwise direction, the winding wire is wound around the tooth T7 by several turns in a counter-clockwise direction, and then the winding wire is hooked up to the segment S11.

Next, the winding wire is hooked up to the segment S17 and the segment S5 sequentially from the segment S11 and returned to the segment S11, and thus a closed-loop equalizer is formed, with which segments S11, S17 and S5 are electrically connected together.

Next, the winding wire is wound around the tooth T6 by several turns in a clockwise direction from the segment S11, the winding wire is wound around the tooth T9 by several turns in a clockwise direction, the winding wire is wound around the tooth T3 by several turns in a clockwise direction, and then the winding wire is hooked up to the segment S18.

Next, the winding wire is hooked up to the segment S6 and the segment S12 sequentially from the segment S18 and returned to the segment S18, and thus a closed-loop equalizer is formed, with which segments S18, S6 and S12 are electrically connected together.

Next, the winding wire is wound around the tooth T2 by several turns in a counter-clockwise direction from the segment S18, the winding wire is wound around the tooth T8 by several turns in a counter-clockwise direction, the winding wire is wound around the tooth T5 by several turns in a counter-clockwise direction, and then the winding wire is hooked up to the segment S7.

In the second embodiment, the closed-loop equalizers and the coil windings are formed alternately, and all the equalizers and all the coil windings can be formed by a single, continuous winding wire where the winding wire is not cut during winding.

In this embodiment, each of the coil windings includes P (P is the number of pole pairs) sub-coil windings formed continuously, the P sub-coil windings are wound on P teeth in a same winding direction respectively, and a distance between any two teeth among the P teeth is an even multiple of the pole pitch.

In this embodiment, any two coil windings formed sequentially have opposite winding directions, where one of the coil windings is wound in a clockwise direction and the other of the coil windings is wound in a counter-clockwise direction.

In this embodiment, two coil windings are wound on each of the teeth, and the two coil windings have opposite winding directions.

In this embodiment, a few of the segments are directly connected to two coil windings, and the two coil windings have opposite winding directions.

Preferably, the following relational expression may be met for the electric brushes and the commutator of the stator in the motor according to the invention:

$${W}_{b} < {D}_{c} \cdot sin ( {sin}^{- 1} ( \frac{δ}{{D}_{c}} ) + \frac{π}{2 mP} )$$

where Wb indicates a width of the electric brush in a rotation direction of the commutator;
Dc indicates an outside diameter of the commutator; and
δ indicates a width of a gap between two adjacent segments of the commutator.

Utilization ratio for the coil windings can be further improved and it is beneficial to commutation of the motor, where the above-described constraint is met for the electric brushes and the commutator.

In the description and claims of the present application, each of the verbs “comprise”, “include”, “contain” and “have”, and variations thereof, are used in an inclusive sense, to specify the presence of the stated item or feature but do not preclude the presence of additional items or features.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of example only, and various other modifications will be apparent to persons skilled in the field without departing from the scope of the invention as defined by the appended claims.

1. A brushed DC motor, comprising:
a stator comprising 2P magnetic poles, wherein P is an integer greater than 1;
a rotor rotatably mounted onto the stator, wherein the rotor comprises a shaft, a rotor core fixed to the shaft, a commutator and a winding; the rotor core has m×P teeth, m is an integer greater than 2; the commutator has 2m×P segments; the winding comprises several coil windings wound on the teeth and electrically connected to a respective segment,
wherein the 2m×P segments are divided into 2m groups, each group has P segments, the P segments are connected conductively via one equalizer sequentially, and
wherein the equalizer for at least one group of the 2m groups of segments and all of the coil windings are formed by a continuous winding wire.

2. The motor of claim 1, wherein each equalizer forms a closed loop.

3. The motor of claim 1, wherein all of the equalizers and all of the coil windings of the rotor are formed by the continuous winding wire.

4. The motor of claim 3, wherein each of the coil windings is wound on a respective tooth, and two ends of each of the coil windings wind around the shaft by a mechanical angle of 90 degrees and are hooked up to two corresponding segments respectively.

5. The motor of claim 3, wherein any two coil windings formed sequentially have opposite winding directions, wherein one of the coil windings is wound in a clockwise direction and the other of the coil windings is wound in a counter-clockwise direction.

6. The motor of claim 3, wherein two coil windings are wound on each of the teeth, and the two coil windings have opposite winding directions.

7. The motor of claim 3, wherein a few of the coil windings and all of the equalizers are formed alternately and the remaining coil windings are formed sequentially.

8. The motor of claim 3, wherein the stator has two electric brushes electrically connected to segments of the commutator, and six parallel branches are formed by the winding to be connected to the two electric brushes.

9. The motor of claim 3, wherein each of the segments is connected directly to two coil windings, and the two coil windings have opposite winding directions.

10. The motor of claim 3, wherein each of the coil windings comprises P sub-coils, the P sub-coils are wound on the P teeth of the rotor respectively; and a distance between two adjacent sub-coils among the P sub-coils is an even multiple of a pole pitch.

11. The motor of claim 10, wherein the stator has two electric brushes electrically connected to segments of the commutator, and two parallel branches are formed by the winding of the rotor to be connected to the two electric brushes.

12. The motor of claim 10, wherein all of the coil windings and all of the equalizers are formed alternately by the continuous winding wire.

13. The motor of claim 10, wherein some of the segments are connected directly to two coil windings, and the two coil windings have opposite winding directions.

14. The motor of claim 1, wherein P is equal to 3, and m is equal to 3.

15. The motor of claim 1, wherein the following relational expression is met for the electric brushes and the commutator of the stator:
$${W}_{b} < {D}_{c} \cdot sin ( {sin}^{- 1} ( \frac{δ}{{D}_{c}} ) + \frac{π}{2 mP} )$$
wherein W_{b} indicates a width of the electric brush in a rotational direction of the commutator;
D_{c} indicates an outside diameter of the commutator; and
δ indicates a width of a gap between two adjacent segments of the commutator.
